(19) United States
(12) Patent Application Publication
(10) Pub. No.: US 2017/0163670 A1
(43) Pub. Date: Jun. 8, 2017

(54) PACKET LOGGING

(71) Applicant: HEWLETT PACKARD ENTERPRISE DEVELOPMENT LP, Houston, TX (US)

(72) Inventors: Pratyusa K Manadhata, Princeton, NJ (US); William G. Horne, Princeton, NJ (US)

(21) Appl. No.: 15/116,018

(22) PCT Filed: Apr. 30, 2014
(86) PCT No.: PCT/US2014/036149

§ 371 Date: Aug. 2, 2016

(51) Int. Cl. H04L 29/06; H04L 29/12

(52) U.S. Cl. CPC H04L 63/1425; H04L 63/101; H04L 63/0227; H04L 63/1441; H04L 61/1511; H04L 67/42

(57) ABSTRACT

Systems and methods associated with packet logging are described. One example method includes testing a packet obtained from a packet stream against a whitelist and a blacklist. The method also includes dropping the packet when the packet tests positive against the whitelist. The method also includes providing the packet to a security manager when the packet tests positive against the blacklist. The method also includes logging the packet when the packet tests negative against the whitelist.

### BACKGROUND

The domain name system (DNS) is used to translate web addresses (e.g., www.[example].com) into internet protocol (IP) addresses (e.g., 15.201.225.10). For example, when a client seeks to reach a website, the client will send a DNS request identifying the website by its web address to a DNS server. The DNS server will then lookup the web address in a table, and if the address is found in the table, the DNS will respond with a corresponding IP address. DNS is used in internet communications, including malicious traffic (e.g., traffic related to attacks on enterprises).

### BRIEF DESCRIPTION OF THE DRAWINGS

The present application may be more fully appreciated in connection with the following detailed description taken in conjunction with the accompanying drawings, in which like reference characters refer to like parts throughout, and in which:

FIG. 1 illustrates example components associated with packet logging in which example systems and methods, and equivalents, may operate.

FIG. 2 illustrates a flowchart of example operations associated with packet logging.

FIG. 3 illustrates an example security information and event management system associated with packet logging.

FIG. 4 illustrates another example security information and event management system associated with packet logging.

FIG. 5 illustrates an example computing environment in which example systems and methods, and equivalents, may operate.

### DETAILED DESCRIPTION

Systems and methods associated with packet logging are described. The systems and methods are related to scalability and information omission issues in some conventional systems. Presently, logging domain name system (DNS) packet information for analysis is atypical because of the large volume of DNS packets. Additionally, real time analysis on a large volume of packets may require expensive, high performance systems. Further, historical analysis on logged packets requires substantial storage space if every packet is logged for analysis. By way of illustration, for some networks, more than 25 billion DNS packets can pass through these networks on a given day. Consequently, real time analysis and storage requirements on this many packets may be prohibitively expensive as a real time system would have to handle an average of 289-thousand packets per second. A post event analysis is similarly impractical because a system storing the packets would require over 4 petabytes of storage, assuming packets can be compressed to one tenth of their original size and are stored for 90 days.

Though some DNS servers have a limited capacity to log information regarding DNS packets, these servers may incur a performance penalty that increases as the amount of logging increases. However, due to the critical importance of DNS servers in enterprise networks, this type of performance degradation may be unacceptable. Consequently, most DNS servers disable logging. Additionally, even when logging is enabled, some logging techniques may only log DNS queries, when DNS responses may also be useful for detecting and analyzing security events. Further, present logging techniques may fail to log some details within DNS packets that may be useful for detecting and/or preventing security events.

The term security event generally refers to events which may indicate a security breach or a security related problem on a computer protected by systems and methods disclosed herein. These may include, for example, malware that have installed themselves on protected clients, denial of service attacks against protected clients, and so forth. Additionally, security events may also include unauthorized data transmissions from protected systems (e.g., because someone is attempting to transmit confidential information from a secure client). Other security events may also be detected and/or mitigated due to disclosed systems and methods.

Thus, to avoid delaying traffic, a device may be placed in between a DNS server and clients (e.g., computers) in communication with the server. The device may copy DNS packets from a packet stream between the DNS server and the clients to an appliance specifically designed to facilitate out of band logging of the normal DNS packet stream so the packet stream is not slowed down. To determine whether a packet might be associated with a security event, the appliance may compare the packets to a whitelist and a blacklist.

Comparing packets to the whitelist may allow the appliance to avoid logging packets associated with known benign entities. These entities may be, for example, domains, IP addresses, applications, clients, and so forth. By way of illustration, for some large companies, internal DNS traffic may make up a substantial portion of DNS traffic processed by a DNS server. However, it is very likely that the vast majority of this traffic is legitimate and not associated with a security event. Domains associated with external websites may also be whitelisted based on additional criteria. By way of illustration a small number of websites drive a substantial amount of web traffic, and many of these domains are managed by reputable companies that are very unlikely to be associated with a security event. Consequently, the whitelist may be a list of known benign domains (e.g., Google, Yahoo, Amazon, LinkedIn). They may be culled from a list of high traffic websites (e.g., Alexa), or generated by examining traffic over time and automatically or manually whitelisting commonly accessed domains that are unlikely to be associated with a security event.

IP addresses may also be useful for detecting malicious events. When a DNS request is sent based on a domain name, a DNS server will typically respond with an IP address that will then be used for routing a subsequent packet across a network (e.g., the Internet). When a DNS response contains a whitelisted IP address the DNS response packet may be dropped because it is likely not associated with a malicious event.

In addition to domains, other packet attributes may be whitelisted. For example, if an application is known to be secure but generate substantial DNS traffic, packets associated with the application may be whitelisted so they are not logged. Similarly, if a specific client is designated a low priority client for the purpose of security, packets traveling to and from this client may also be whitelisted. Other packet attributes may also be whitelisted.

Comparing packets to the blacklist may allow the appliance to identify traffic associated with known security events and begin to take remedial measures regarding those events. For example, many malware attempt to communicate with command and control servers for the purpose of providing data and/or obtaining instructions. If a malware on a client attempts to reach one of these servers, a DNS request packet having a known domain of the command and control server may be matched to the blacklist, causing an alert to be generated regarding the packet and/or the client. A similar action may be taken if a DNS response packet contains a blacklisted IP address associated with the command and control server.

Additionally, DNS packets may include known attack signatures such as a pointer loop, a time to live (TTL) of zero, a malformed header, a mismatch in packet length and a length designated in a head of the packet, and so forth. When an attack signature is detected, the packet may also be flagged so that a remedial measure may be taken in response to the packet. The flag may also ensure that the information regarding the packet is logged to facilitate taking a remedial measure and/or for future analysis. Remedial measures may include blocking communications to and/or from the affected client, alerting an administrator so that the affected client may be repaired (e.g., a malware removed from the affected client), and so forth.

In some cases, it may be appropriate to add attributes to the blacklist that would cause otherwise benign marked packets to be logged. For example, if a client has a high priority for the purpose of security (e.g., a CEO's client, which stores highly sensitive and/or confidential information), it may be desirable to log all packets to and from this client. Thus, the client may be blacklisted to ensure these packets are logged. Similarly, packets generated by a specific application may also be blacklisted (e.g., to detect improper file sharing over a network).

If a packet does not match a whitelist or blacklist entry, the appliance may not be able to quickly determine if the packet is benign or if the packet is associated with a security event. Consequently, these packets may be logged for later analysis. This analysis may be performed when a security event is detected. Analysis may also be performed to monitor performance of a system or application. For example, if a client is creating excess traffic that does not survive the whitelisting process, analysis may indicate improvements that could be made to the client to reduce traffic. Logging packets may include extracting information regarding the packet such as time-to-live values which may be useful for determining if the packet is associated with a malicious event.

By way of illustration, DNS packets have a predefined format that includes a header, a question, and a number of resource records, each of which also has a predefined format. To efficiently log information from a DNS packet, relevant fields from the header, question, and resource records may be extracted and stored as a collection of “field name, value” pairs associated with the DNS packet.

Two example attributes that may be useful for detecting malicious traffic are the time-to-live (TTL) attribute and the Canonical Name (CNAME) resource record attribute. So called “fast-flux” domains change mappings between domain names and IP addresses often to avoid detection, sometimes using very low TTL values. Consequently, by logging TTL values and examining low TTL values, fast-flux domains may be detected and attacks associated with such domains may be mitigated. CNAME attributes essentially serve as aliases between domain names. For example, [alias].com might be a CNAME for [example].com so that traffic directed at [alias].com is ultimately directed towards [example].com. Thus, even if nothing is known about an alias domain name, traffic directed towards a malicious domain may be detected by logging CNAME information.

By using the whitelist to filter benign domains, and a blacklist to identify known threats, the number of packets stored for logging may be reduced to a fraction of their original numbers, substantially reducing storage space required to store DNS packets over time. By way of illustration, example whitelists and blacklists have been able to reduce approximately 3.8 billion DNS packets received by a data center in a day to 56 million packets for logging including 9.6 million packets associated with malicious events that could then be mitigated.

It is appreciated that, in the following description, numerous specific details are set forth to provide a thorough understanding of the examples. However, it is appreciated that the examples may be practiced without limitation to these specific details. In other instances, well-known methods and structures may not be described in detail to avoid unnecessarily obscuring the description of the examples. Also, the examples may be used in combination with each other.

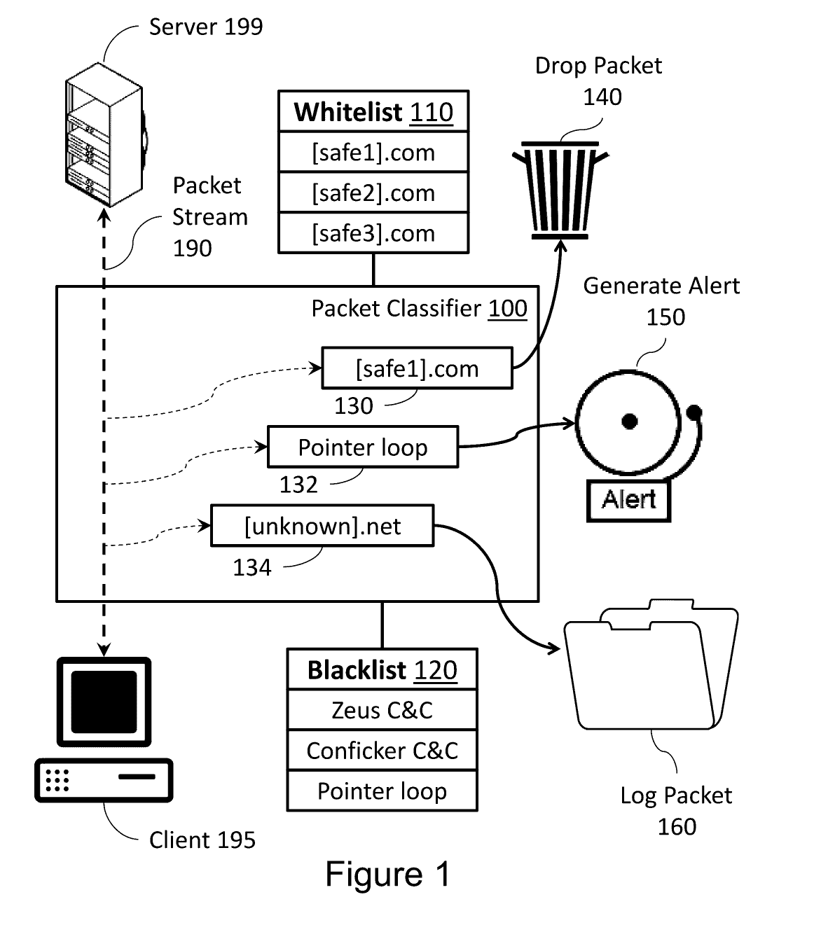

FIG. 1 illustrates components associated with packet logging in which example systems and methods, and equivalents, may operate. FIG. 1 includes a packet classifier 100. Packet classifier 100 may be a system or logic that classifies packets from a packet stream 190. Packet stream 190 may include packets travelling between a server (e.g., a DNS server) 199 and a client 195. If packet classifier 100 is placed close to server 199, packets from multiple packet streams 190 between server 199 and clients 195 may be copied using a single packet classifier 100. If server 199 is a DNS server, packets sent from client 195 to server 199 may be DNS request packets and packets sent from server 199 to client 195 may be DNS response packets.

Packet classifier 100 may classify packets from packet stream 190 as benign, malicious, or unknown for the purpose of detecting and/or identifying malicious attacks against a network of which client(s) 195 is a member. These attacks may include, for example, external attacks (e.g., pointer loops to cause a denial of service attack on a DNS server), and internal infections (e.g., a malware installed on client 195). To avoid introducing a delay into the majority of packets that are legitimate traffic and not associated with a security event, packet classifier 100 may copy the packets for analysis out of band, instead of analyzing them in band. Thus, packet classifier 100 has copied three packets, 130, 132, and 134 from packet stream 190 to determine whether these packets are associated with malicious events.

Packet classifier 100 may classify the packets based on a whitelist 110, and a blacklist 120. Whitelist 110 includes three domains. These domains may have been selected, for example, by a network administrator based on common network traffic that is known to be not associated with malicious web traffic (e.g., malware, denial of service attacks). Alternatively, the whitelist may be generated automatically over time by examining packets and noting which domains are not associated with malicious events. Whitelist 110 may also specify that certain clients, IP addresses, applications, and other packet attributes indicate that a packet is benign and therefore does not need to be logged.

Blacklist 120 includes two domains associated with known malware, the Zeus Trojan and the Conficker worm, as well as a known attack signature, a pointer loop. Blacklist 120 may also include other attributes that indicate when a packet is associated with a malicious event. As with whitelist 110, blacklist 120 may be generated based on input from a network administrator, or automatically based on analysis of packets.

In this example, packet classifier 100 is shown analyzing three packets, 130, 132, and 134. First the domain of packet 130 is analyzed. Because the domain in packet 130, “[safe1].com”, is in the whitelist, packet classifier 100 may classify packet 130 as benign. Consequently, because the packet has been classified as benign, the packet may be ignored for security purposes and dropped at 140 for the purpose of analysis of malicious network traffic. As mentioned above, packet 130 is a copy of a packet from packet stream 190. Therefore dropping packet 130 at 140 may effectively remove packet 130 from a set of packets that are eventually analyzed for malicious activity, but will not stop transmission of a packet in packet stream 190 that packet 130 was copied from.

Packet 132 may be analyzed next. In this example, a pointer loop is detected in packet 132, which has been identified in the blacklist as being associated with a malicious event. This may cause packet classifier to classify packet 132 as malicious, and an alert may be generated at 150 based on packet 132. The alert may be sent to, for example, a security information and event management (SIEM) system that tells a network administrator when a malicious attack against a network protected by the SIEM is detected. This alert may identify a course of action that the administrator may take to protect the network against the attack. For example, if packet 132 included DNS information related to the Zeus command and control server instead of a pointer loop, the SIEM may tell the administrator that client 195 is infected with the Zeus malware so that the administrator can take steps to mitigate the infection (e.g., obtain and reimage the machine). Because packet 132 is associated with the blacklist, information regarding packet 132 may be logged so that later analysis may be performed on packet 132 to enhance mitigation of any security events associated with the packet 132.

When packet 134 is analyzed, packet classifier 100 may not detect any attributes associated with packet 134 that associate packet 134 with either whitelist 110 or blacklist 120. The domain “[unknown].net” could be, for example, a completely harmless website belonging to an employee where they post travel photos, or a malicious website that attempts to download malware onto the system of someone who accesses the website. Consequently packet 134 may be logged at 160 for later analysis. If “[unknown].net” turns out to be harmless, the information logged may eventually be pruned from the log at a later time. However, if it is later determined that the domain is associated with a malicious event, the information logged at 160 regarding packet 134 may be analyzed. This analysis may facilitate determining a manner of mitigating the malicious event in the future to improve network security.

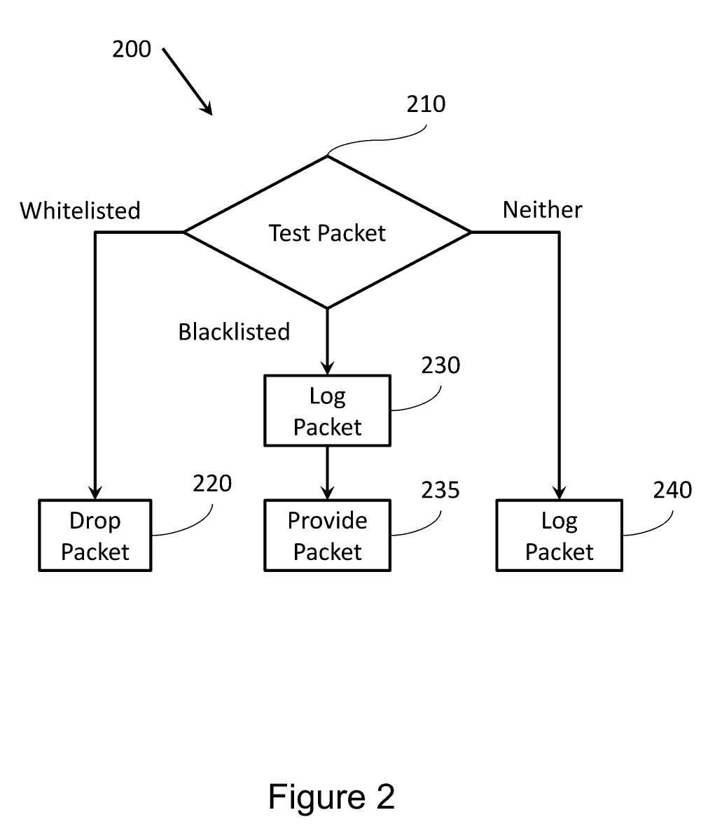

FIG. 2 illustrates a method 200 associated with packet logging. Method 200 may be embodied on a non-transitory computer-readable medium storing computer-executable instructions that when executed by a computer cause the computer to perform method 200. Method 200 may facilitate classifying DNS packets as benign, malicious, or unknown, and taking actions based on these classifications. Parallelization may facilitate classifying multiple packets at substantially the same time by multiple instances of method 200. Method 200 includes testing a packet at 210. The packet may be obtained from a packet stream. The packet stream may include packets traveling between a domain name system (DNS) server and a set of clients in communication with the DNS server. Consequently, the packet tested at 210 may be a DNS packet.

The packet may be tested against a whitelist and a blacklist. The whitelist may include benign domains, benign IP addresses, low priority clients, low priority applications, benign packet signatures, and so forth. Benign domains and IP addresses may be, for example, domains and IP addresses associated with a company performing method 200, domains and IP addresses culled from a list of known reliable domains, domains and IP addresses identified by a process as having a low likelihood of being associated with a security event, and so forth. A low priority client may be for example, a client that has a low risk to a company performing method 200 if the client is compromised (e.g., the client has no confidential data). A low priority application may be an application that a company performing method 200 believes is secure. Benign packet signatures may include attributes that indicate that the packet is unlikely to be associated with a security event. For example, packets associated with certain types of applications, certain transmission protocols, and so forth, may be whitelisted to reduce the number of packets flagged for logging.

Consequently, a packet attribute matching an entry on the whitelist may indicate that the packet is not associated with a security event for which logging is efficient and that therefore the packet may be safely ignored. Thus, when the packet tests positive against the whitelist, method 200 includes dropping the packet at 220. Upon dropping a packet, method 200 may allow the packet to be overwritten in memory as space is needed, and then move on to classifying a next packet that is received by a system performing method 200.

The blacklist may include malicious domains, malicious IP addresses high priority clients, high priority applications, attack signatures, and/or other packet attributes that indicate a packet is associated with a malicious event. A malicious domain or IP address may be, for example, a domain known to be associated with a specific malware. By way of illustration, many malware obtain instructions and/or provide data to specific online domains. These domains and/or their associated IP addresses may be blacklisted so that when a packet is attempting to reach one of these domains or IP addresses, information regarding the packet is logged and the packet is flagged as being potentially associated with a security event.

A high priority client may be, for example, a client that is very important to a company performing method 200. Such clients may include, for example, a client belonging to a CEO of the company (e.g., a CEO's laptop storing highly sensitive and/or confidential information), a client with highly confidential information belonging to the company and so forth. Even though blacklisting a client may cause many otherwise benign packets to be logged and/or identified as potentially malicious, it may be worth logging and flagging these packets to maintain assurances that the high priority client is secure. A high priority application may be for example, an application that a company performing method 200 does not want operating over their network (e.g., certain illegal file sharing applications).

An attack signature may describe packet contents (e.g., a pointer loop) that indicate the packet is malicious. Logging and flagging these packets may be desirable because they may facilitate preventing future instances of these packets from affecting clients within the network. Further, if the packet was received from a client within the network, this may indicate that the client is infected with a malware which may require removal by, for example, a network administrator or a security management application.

When the packet tests positive against the blacklist, method 200 includes logging the packet at 230. Logging the packet may include extracting security information from the packet and storing the packet and the extracted security information for future analysis. When method 200 is integrated with a specific security system (e.g., a security information and event manager (SIEM)), logging the packet may include collecting and formatting information associated with the packet into a data format used by the security system.

Once information regarding the packet is logged, method 200 includes providing the packet at 235. The packet may be provided in its packet form, in a data format associated with an entity to which the packet is being provided, and so forth. The packet may be provided to, for example, a security system that attempts to mitigate security events upon detecting malicious traffic. Consequently, logging the packet may also ensure so that important details regarding the packet are retained to facilitate this mitigation. The security system may be, for example, a SIEM that alerts a professional when a malicious event occurs and indicates to the professional how the event can be mitigated. For example, when the event is a malware on a client, the SIEM may inform the professional how to remove the malware from the client.

When the packet tests negative against the whitelist and the blacklist, method 200 includes logging the packet at 240. A packet testing negative against the whitelist and the blacklist indicates that method 200 cannot quickly classify the packet as benign or malicious and therefore it is worth maintaining in the event a malicious event is later detected. For example, if a first packet is received is associated with a domain that is neither whitelist nor blacklisted, the first packet may be logged for later analysis. If a second packet associated with the domain is received that contains an attack signature (e.g., a pointer loop), analysis of other packets associated with the domain, including the first packet, may be valuable to facilitate mitigating security events associated with the domain in the future. Similarly, if a malware is later found on a client, and it is determined that the malware originated from the domain from which the first packet originated, the first packet may be analyzed to facilitate finding a way to prevent the malware from penetrating clients in the future.

In another example, method 200 may include testing a packet obtained from a packet stream against a whitelist and a blacklist to determine a result, and an action may be performed based on the result. When the result indicates that the packet tests positive against the whitelist, the action may include dropping the packet. When the result indicates the packet tested negative against the whitelist, the packet may be logged. Finally, when the result indicates that the packet tested positive against the blacklist, the packet may be provided to a security manager.

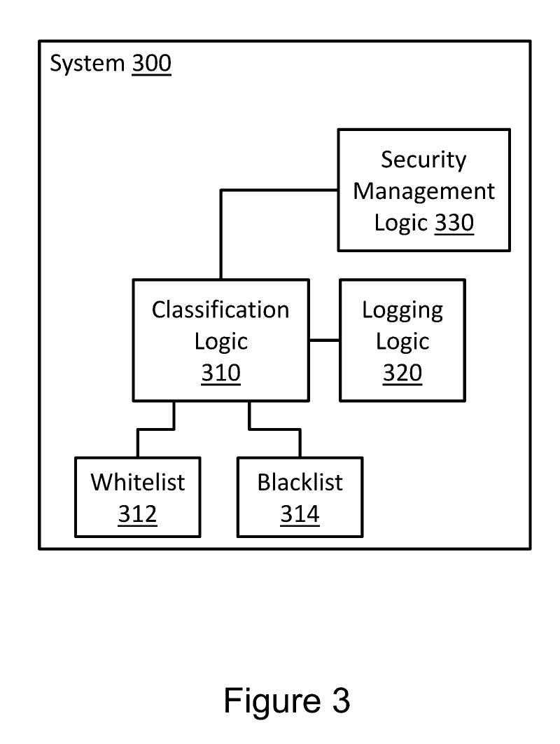

FIG. 3 illustrates a system 300 associated with packet logging. System 300 may be or may communicate with, for example, a security information and event manager (SIEM). System 300 includes a classification logic 310. Classification logic 310 may classify domain name system (DNS) packets as benign, malicious, and unknown based on a whitelist 312 and a blacklist 314. A classified DNS packet may be classified as benign if an attribute associated with the classified DNS packet appears on whitelist 312. Attributes may include, for example, domains, signatures, clients, applications, and so forth. Additionally, the classified DNS packet may be classified as malicious if an attribute associated with the classified DNS packet appears on blacklist 314. Consequently, the classified DNS packet may be classified as unknown if a domain associated with the classified DNS packet does not appear on whitelist 312 and does not appear on blacklist 314.

System 300 also includes a logging logic 320. Logging logic 320 may store unknown classified DNS packets and malicious classified DNS packets for subsequent analysis. The subsequent analysis may be performed in response to detection of a malicious event. The subsequent analysis may include identifying attributes of the malicious event so that future events sharing attributes with the malicious event may be blocked. Logging logic 320 may also collect data regarding logged DNS packets and format the data for use by entities performing the subsequent analysis.

System 300 also includes a security management logic 330. Security management logic may generate an alert based on a malicious classified packet. The alert may indicate an attack against a network or client protected by system 300. The alert may be provided to a user (e.g., a professional responsible for maintaining security of the network or client). The alert may also indicate a course of action to take to protect the network or client against the attack. For example, if an alert indicates a malware on a client within the network, the alert may tell the user how to remove the malware from the client. In another example, the alert may indicate a course of action taken by the system to automatically protect the network against the attack.

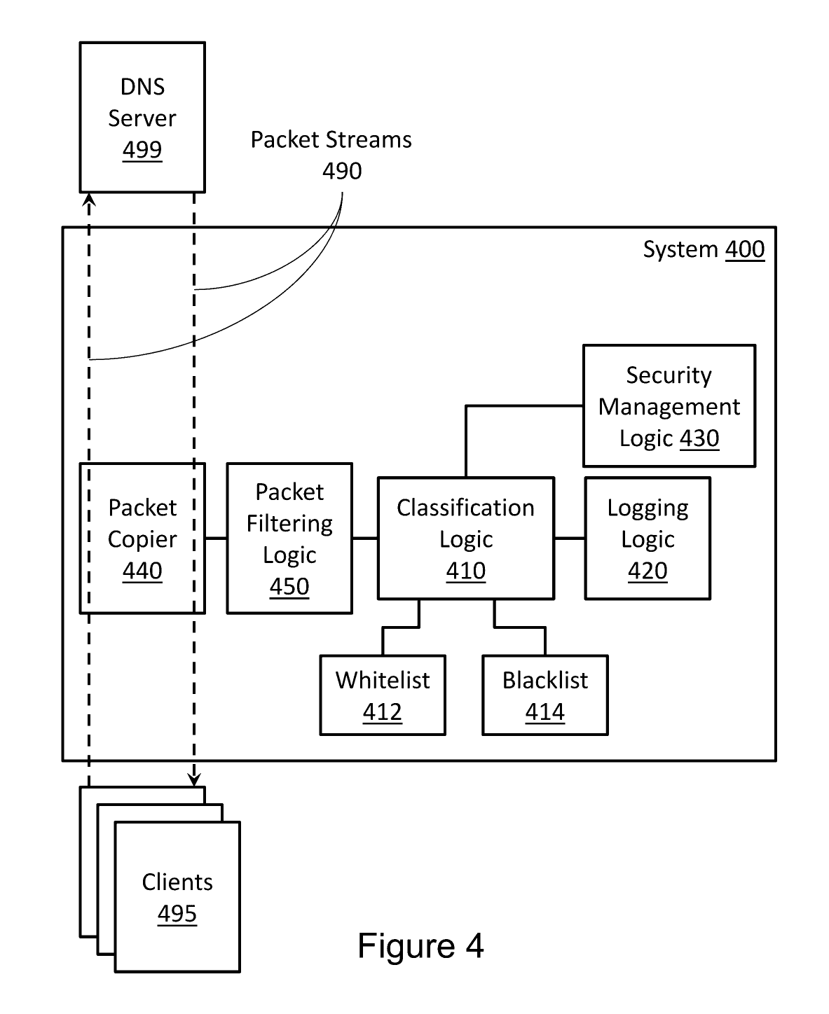

FIG. 4 illustrates a system 400 associated with packet logging. System 400 includes several items similar to those in system 300 (FIG. 3). For example, system 400 includes a classification logic 410 that classifies domain name system (DNS) packets based on a whitelist 412 and a blacklist 414, a logging logic 420, and a security management logic 430.

System 400 also includes a packet copier 440. Packet copier 440 may provide a set of packets to a packet filtering logic 450. The set of packets may be obtained from packets in packet streams 490 traveling between a DNS server 499 and clients 495 communicating with DNS server 499. Packet copier 440 may be, for example, a network tap, a port mirror, and so forth. Packet filtering logic 450 may filter DNS packets from the set of packets and provide the DNS packets to classification logic 410. In one example, packet filtering logic 450 may provide the DNS packets directly to classification logic 410 using direct memory access techniques. Direct memory access techniques may allow classification logic 410 to perform its classification function without managing the loading and storing of DNS packets to its memory. This may potentially increase the throughput of classification logic 410 because managing loading and storing of data may be slow, processing intensive functions.

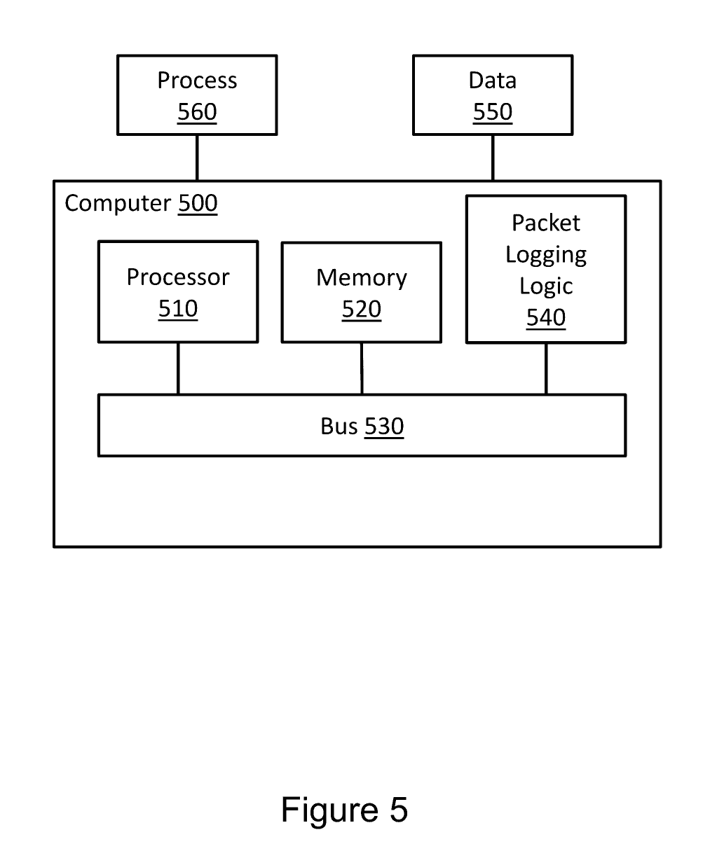

FIG. 5 illustrates an example computing environment in which example systems and methods, and equivalents, may operate. The example computing device may be a computer 500 that includes a processor 510 and a memory 520 connected by a bus 530. The computer 500 includes a packet logging logic 540. In different examples, packet logging logic may be implemented as a non-transitory computer-readable medium storing computer-executable instructions in hardware, software, firmware, an application specific integrated circuit, and/or combinations thereof.

The instructions, when executed by a computer, may cause the computer to drop a domain name system (DNS) packet when an attribute with which the packet is associated matches is a whitelisted attribute. The DNS packet may be copied for out of band analysis from a packet stream between a DNS server and a client in communication with the DNS server. The instructions may also cause the computer to generate an alert regarding the DNS packet when an attribute with which the packet is associated matches a blacklisted attribute. The instructions may also cause the computer to log information regarding the DNS packet when the packet has no whitelisted attributes and no blacklisted attributes.

The instructions may also be presented to computer 500 as data 550 and/or process 560 that are temporarily stored in memory 520 and then executed by processor 510. The processor 510 may be a variety of various processors including dual microprocessor and other multi-processor architectures. Memory 520 may include volatile memory (e.g., read only memory) and/or non-volatile memory (e.g., random access memory). Memory 520 may also be, for example, a magnetic disk drive, a solid state disk drive, a floppy disk drive, a tape drive, a flash memory card, an optical disk, and so on. Thus, memory 520 may store process 560 and/or data 550. Computer 500 may also be associated with other devices including other computers, peripherals, and so forth in numerous configurations (not shown).

It is appreciated that the previous description of the disclosed examples is provided to enable any person skilled in the art to make or use the present disclosure. Various modifications to these examples will be readily apparent to those skilled in the art, and the generic principles defined herein may be applied to other examples without departing from the spirit or scope of the disclosure. Thus, the present disclosure is not intended to be limited to the examples shown herein but is to be accorded the widest scope consistent with the principles and novel features disclosed herein.

What is claimed is:

1. A non-transitory computer-readable medium storing computer-executable instructions that when executed by a computer cause the computer to:
test a packet obtained from a packet stream against a whitelist and a blacklist;
drop the packet when the packet tests positive against the whitelist;
log the packet when the packet tests negative against the whitelist; and
provide the packet to a security manager when the packet tests positive against the blacklist.

2. The non-transitory computer-readable medium of claim 1, wherein the packet stream includes packets traveling between a domain name system (DNS) server and a set of clients in communication with the DNS server, and wherein the packet is a DNS packet.

3. The non-transitory computer-readable medium of claim 1, wherein the whitelist comprises benign domains and benign internet protocol (IP) addresses, and wherein the blacklist comprises malicious domains and malicious IP addresses.

4. The non-transitory computer-readable medium of claim 1, wherein the whitelist comprises low priority clients and low priority applications, and wherein the blacklist comprises high priority clients and high priority applications.

5. The non-transitory computer-readable medium of claim 1, wherein the whitelist comprises benign signatures that indicate a packet is associated with a benign event and wherein the blacklist comprises attack signatures that indicate a packet is associated with a malicious event.

6. The non-transitory computer-readable medium of claim 1, wherein logging the packet comprises extracting security information from the packet and storing the packet and the extracted security information for future analysis.

7. A system, comprising:
a classification logic to classify domain name system (DNS) packets as benign, malicious, and unknown based on a whitelist and a blacklist;
a logging logic to store unknown classified DNS packets and malicious classified DNS packets for subsequent analysis; and
a security management logic to generate an alert based on one of the malicious classified DNS packets.

8. The system of claim 7, wherein the subsequent analysis is performed in response to detection of a malicious event and where the subsequent analysis identifies attributes of the malicious event to facilitate blocking events sharing the attributes of the malicious event.

9. The system of claim 7, comprising a packet filtering logic to provide DNS packets from a set of packets to the classification logic.

10. The system of claim 9, comprising a packet copier to provide the set of packets to the packet filtering logic, wherein the set of packets is obtained from packets traveling between a DNS server and clients communicating with the DNS server.

11. The system of claim 10, wherein the packet copier is one of a network tap, and a port mirror.

12. The system of claim 7, wherein the alert indicates an attack against a network protected by the system, and a course of action to take to protect the network against the attack.

13. The system of claim 7, wherein a classified DNS packets is classified as benign when a domain associated with the classified DNS packet appears on the whitelist, wherein the classified DNS packet is classified as malicious if a domain associated with the classified DNS packet appears on the blacklist, and wherein the classified DNS packet is classified as unknown if a domain associated with the classified DNS packet does not appear on the whitelist and does not appear on the blacklist.

14. A non-transitory computer-readable medium storing computer-executable instructions that when executed by a computer cause the computer to:
drop a domain name system (DNS) packet when an attribute with which the packet is associated matches a whitelisted attribute;
generate an alert regarding the DNS packet when an attribute with which the packet is associated matches a blacklisted attribute; and
log information regarding the DNS packet when the packet has no whitelisted attributes.

15. The non-transitory computer-readable medium of claim 14, where the DNS packet is copied for out of band analysis from a packet stream between a DNS server and a client in communication with the DNS server.
